(19) United States
(12) Patent Application Publication
(10) Pub. No.: US 2016/0027125 A1
(43) Pub. Date: Jan. 28, 2016

(54) Report Generation

(71) Applicant: Wealthchart Limited, London (GB)

(72) Inventor: Adam Bryce, London (GB)

(21) Appl. No.: 14/806,065

(22) Filed: Jul. 22, 2015

(30) Foreign Application Priority Data
Jul. 25, 2014 (GB) 1413258.3

(51) Int. Cl. G06Q 40/00

(52) U.S. Cl. CPC G06Q 40/12

(57) ABSTRACT

Method and system for obtaining a set of financial data including entries associated with expenses, revenue, equity, assets and/or liabilities. Ordering the financial data entries according to one or more criterion defined by user preferences. Processing the ordered financial data by applying one or more logical procedures to incorporate the financial data into a natural language narrative of a financial report. Communicating the financial report to the user.

### CROSS-REFERENCE TO RELATED APPLICATIONS

This application claims priority to United Kingdom Application No. 1413258.3, filed Jul. 25, 2014, entitled “Report Generation”, the contents of which are herein incorporated by reference in their entirety for all purposes.

### FIELD OF THE INVENTION

The present invention relates to a computer implemented method and system for obtaining and processing information automatically and generating a report from the processed information more efficiently.

### BACKGROUND OF THE INVENTION

Data and especially financial data can be difficult to review and analyse quickly and accurately. This is particularly the case where data must be acquired from different sources and in different formats. It is also often necessary to present this type of data effectively using electronic devices.

Someone may own a portfolio of stocks with each stock having a current price, purchase price, holding amount, purchase data and dividend yield. With this information, a person may determine whether to buy more stock, sell the stock or make no change to their position. However, as the number of different stocks in a portfolio increases, then this can lead to an increased complexity when presenting these data to the user. This can be especially difficult or confusing to analyse with a large portfolio in different currencies, for example.

One approach is to summarise or abridge the data and present to a user or consumer an abridged data set instead of a more complete data set. In other words, the number fields may be limited or restricted. However, this may leave out important information. For example, only the total price change since date of purchase may be presented but this may make it difficult for the user to use the supplied data to make any decisions. For example, the price may have gone up or gone down significantly since purchase, with total return masking more recent performance. The problem may be more acute when the data must be presented on a device with a small display like a tablet computer or smart phone.

Furthermore, individual institutions or financial service companies may have their own websites and tools for presenting information to their users or customers. However, a customer may have accounts with different institutions or financial service companies and so they will need to use multiple tools and be presented with data in different formats. This may further increase complexity and makes it difficult for a user to monitor their overall financial position and relative performance of investments held.

People are becoming increasingly mobile and global. They may spend time in different countries where they interact and transact with local institutions. Over time, these people may develop a portfolio of different assets and liabilities (e.g. debt, mortgages etc.) denominated in different currencies. This makes it more difficult to keep track of their overall financial situation and make more informed financial decisions. Furthermore, certain assets may not be quoted financial instruments (like exchange listed stocks) with simple valuations. These may include real property and physical assets such as cars and artworks, for example. It can therefore be difficult for a person to obtain an overall picture of their financial position.

Therefore, there is required a method and system that processes information and presents data to a user device in a more effective, efficient and usable way that overcomes these problems.

### SUMMARY OF THE INVENTION

Against this background and in accordance with a first aspect there is provided a method of generating a financial report comprising the steps of:

obtaining a set of financial data including entries associated with expenses, revenue, equity, assets and/or liabilities;

ordering the financial data entries according to one or more criterion defined by user preferences;

processing the ordered financial data by applying one or more logical procedures to incorporate the financial data into a natural language narrative of a financial report; and

communicating the financial report to the user. This provides the user with a report optimised to their particular requirements in a more efficient and effective manner. The entries relate to items and categories generally in accounting systems or other wealth sources and applications. The entries may be primary data (e.g. a share prices) or secondary or derived data (e.g. the total value or all shares held or their percentage change since being purchased). Logical procedures may include if/then/else statements (or any combination of these), Boolean, rules or other operators and functions, for example. The financial report may be generated by the logical procedures incorporating the financial data into narrative text by natural language processing. In other words, the report has financial data embedded in a narrative or story. This allows the user to view and understand the report more efficiently and effectively as it is presented more clearly and understandably. This improves readability, enabling users to perform their task of understanding the report more efficiently. This also provides an improved design and use of a graphic interface used to display the financial report. The natural language narrative may form all or only part of the financial report. For example, a small report may comprise just the narrative (which may be sent to the user over SMS, for example). A larger financial report may contain more text or narrative. Further types of reports may include other components such as graphs and tables, for example. More than one report type may be generated in some examples.

Optionally, the one or more logical procedures may be executed according to attributes within the user preferences.

Optionally, the method may further comprise the step of obtaining new or updated user preferences from the user. Therefore, the user may obtain an improved or further customised report. For instance, the user may want to change the emphasis of the report from overall financial position to one that facilitates in making decisions (e.g. buying and/or sell assets).

Preferably, the steps may be repeated to generate and communicate a further financial report to the user. Therefore, new or following reports will incorporate user changes or updates to their preferences.

Optionally, the one or more logical procedures include any one or more of: including the financial data entries within textual templates; applying one or more rules to the financial data; formatting or translating the financial data using one or more templates; and executing an algorithm. Other logical procedures may be used.

Preferably, the processing step may further comprise:

limiting the ordered financial data entries to include in the financial report based on the user preferences. Limiting may be based on an absolute number (e.g. no more than a user defined number of entries or events) or based on value (e.g. limited to showing entries or changes above a certain or user defined currency value).

Optionally, the ordered financial data may be limited to a number of the most significant entries indicated by a value threshold within the user preferences. Other limits may be applied.

Optionally, the financial report may be communicated to the user by any one or more selected from the group consisting of: email (e.g. in HTML or pdf form), as an SMS message, as a social media feed, mobile application, web page, in HTML, and using an application programming interface, API especially for use with other applications. The financial report may be communicated to the user in other ways and in other formats such as character limited raw text (e.g. for twitter and SMS) and API common formats of XML, JSON and YAML, for example.

Optionally, the financial report may be communicated to the user in the form of a dashboard. The dashboard may be a visual representation illustrating the financial data of a subset of the financial data. This may be in a graphical form (e.g. graphs, bar charts, tables, pie charts, coloured indicators, etc.). The dashboard may be static or dynamic and interactive. In other words, the user may change the form and/or level of detail provided by the dashboard. The dashboard may show a high level view and then provide the facility to drill down in more detail to the underlying data.

Preferably, the dashboard may be customisable.

Preferably, the dashboard customisations may be stored. The customisations may be stored as a template and/or saved with portlets, components and/or parameters, for example.

Preferably, a further or the next financial report may be communicated according to the stored customisations. These customisation may affect all further reports or only the next one.

Optionally, the steps or method (i.e. the generation of the report) are repeated at intervals or are triggered by events.

Optionally, the intervals and/or event triggers may defined by the user preferences. The triggers may be include changes in financial position over a certain or predefined level, external events (e.g. mergers, acquisitions, large forex changes, interest rate or inflation rate changes, etc.)

Optionally, the expenses, revenue, equity, assets and/or liabilities may be any one or more selected from the group consisting of: equity, shares, stock, bonds, debt, rent, income, salary, real estate, mortgage, managed fund, mutual fund, limited stock, share incentive scheme, individual savings account, ISA, transactions, automobile, fine wine, coins, stamps, precious metal, jewellery, art works, business, trust, financial instrument, intellectual property, financial derivatives, commodities, superannuation, and pension. Other expenses, revenue, equity, assets and/or liabilities may be included.

Optionally, the method may further include the step of calculating and adding to the financial report any one or more of: total asset value, total liabilities, asset class value, net wealth, net wealth change, individual asset value change, capital gains, tax, values and/or value changes in different currencies, user goals, user goal position, time to goal at current rate of change, trends over time, time-frame comparison, income, outgoings, comparison of values and trends for different currencies, and inflation.

Optionally, the method may further comprise the steps of:

determining a device type of the user; and

selecting the one or more logical procedures based on the determined device type.

Optionally, the device type may be a mobile device, a smartphone, a feature phone, a tablet computer, a desktop computer, or a laptop computer. Other device types may be used. The type may also include device model, for example.

Optionally, the one or more templates may include any one or more of: sample text, text size, one or more graphical elements; graphical element size, page layout, title, and headline. The templates may include other features or components.

Preferably, obtaining the set of financial data may further include obtaining the financial data from different sources and/or organisations.

Optionally, the set of financial data may be obtained by manually or automatically importing a data set.

Preferably, the financial report may be generated using natural language generation.

Optionally, the user preferences may define the set of financial data to obtain and/or where and how to obtain them.

Advantageously, the method may further comprise the step of:

generating a graphical representation of the financial data; and/or

generating a tabular representation of the financial data. The graphical and/or tabular representations maybe generated by further logical procedures parts of the logical procedures that produce the natural language narrative or other mechanisms, for example.

According to a second aspect, there is provided a system for generating a financial report comprising logic configured to:

obtain a set of financial data including entries associated with expenses, revenue, equity, assets and/or liabilities;

order the financial data entries according to one or more criterion defined by user preferences;

format the ordered financial data using one or more presentation templates to incorporate the financial data into a natural language narrative of a financial report; and

communicate the financial report to the user.

Preferably, the system may further comprise one or more interfaces for receiving financial data for a plurality of financial data sources.

Preferably, the system may further comprise a user interface for obtaining or updating the user preferences. In one example, the user interface may include a selection of selectable questions for the user to choose. The report may take the form of answers to the selected questions.

Preferably, the system may further comprise a web application configured to obtain or update the user preferences and communicate the financial report to the user.

The methods described above may be implemented as a computer program comprising program instructions to operate a computer. The computer program may be stored on a computer-readable medium.

The computer system may include a processor such as a central processing unit (CPU). The processor may execute logic in the form of a software program. The computer system may include a memory including volatile and non-volatile storage medium. A computer-readable medium may be included to store the logic or program instructions. The different parts of the system may be connected using a network (e.g. wireless networks and wired networks). The computer system may include one or more interfaces. The computer system may contain a suitable operation system such as UNIX, Windows® or Linux, for example.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows a schematic diagram of a system for generating a financial report;

FIG. 2 shows a flowchart of a method for generating the financial report of FIG. 1;

FIG. 3 shows a schematic diagram of a financial report presented on a visual display unit;

FIG. 4 shows a schematic diagram of a further financial report presented on a web browser;

FIG. 5 shows a schematic diagram of a further financial report presented on a mobile device;

FIG. 6 shows a schematic diagram of a further financial report presented on a tablet computer;

FIG. 7 shows a table of example financial data;

FIG. 8 shows a further table of example financial data;

FIG. 9 shows a further table of example financial data;

FIG. 10 shows an example chart to be included in the financial report of FIG. 1 and generated from example financial data;

FIG. 11 shows an example screenshot of configuration settings of the system of FIG. 1;

FIG. 12 shows an example screenshot of a financial report generated by the system of FIG. 1;

FIG. 13 shows an example screenshot of a user interface used to provide user preferences used by the system of FIG. 1;

FIG. 14 shows a further example screenshot of a user interface used to provide user preferences used by the system of FIG. 1;

FIG. 15 shows an example screenshot of an interface for providing user account settings;

FIG. 16 shows a further example screenshot of a financial report generated by the system of FIG. 1;

FIG. 17 shows a further example screenshot of a user interface used to provide user preferences used by the system of FIG. 1;

FIG. 18 shows a further example screenshot of a financial report generated by the system of FIG. 1.

It should be noted that the figures are illustrated for simplicity and are not necessarily drawn to scale. Like features are provided with the same reference numerals.

### DETAILED DESCRIPTION OF THE PREFERRED EMBODIMENTS

People increasingly own a wider range of wealth sources. This can be due to changing jobs more frequently (and therefore having multiple pensions and ISA accounts, for example. Furthermore, there is a stronger emphasis on planning for your own financial future and rely less on a state pension. Internet trading allows direct access to previously institutional only markets (e.g. self-administered online share platforms, CFDs, spread betting etc.) Globalisation means that people may live in different countries or may have greater access to and be able to invest in foreign markets.

This can lead to people having a wider range of wealth sources making it more complex and difficult to obtain a summary and see an overall picture of personal wealth and other financial positions. There is a need to simplify and present this information in an intuitive way to help people to make more sensible and timely decisions about their financial affairs. People are used to learning about market financial information in headlines and newspapers. It is therefore advantageous to present such financial information in a more intuitive format delivered in a timely fashion.

Manually generating and processing financial information specific to individuals require significant human labour and can be expensive (in time and resources), slow, and may be subject to conflicts of interest.

Human cost of capital continues to increase. Furthermore, the specific type of human capital required to analyse an individual's financial position is especially expensive, as demonstrated by high advisory costs in the wealth management industry.

With active managed financial services there is always concern about conflicts of interest in recommending products that are more in the interest of the advisor/broker than the investor.

Given the increasingly wide range of investment types available to individuals, it makes manual summarising time consuming. It is particularly difficult to provide a customised report in a timely manner that can be used to make individual and specific financial decisions. This may include decision on selling shares when goals reached or disposing of assets that are not performing relative to expectations or other assets and criterial.

Individuals having a wider range of assets require assistance with viewing and analysing their position but this can be costly to produce manually, expensive, and introduce potentially conflicted and slow advice.

The following system and method are used to provide an application in which users can keep track of data from a number of sources. In particular, the application may be used to monitor personal finance such that wealth and liabilities across many asset classes are tracked. The system and method also provides an up-to-date summary of net wealth at any particular time or when certain events trigger a notification in one or more particular currencies. The method and system may provide results or a summary denominated in one particular currency even though the different assets and liabilities may be in different currencies.

The method and system may provide a historical view of a particular portfolio as well as a current snapshot. This facilitates forecasting and planning of wealth and in particular, personal wealth.

The system may take feeds from different sources including personal finance websites, banks, credit card companies, brokers, asset evaluation sources (stocks and shares, bonds, house price indices, wine brokers, real estate automobile valuers, etc.), tax authorities and central banks, for example. These data feeds may be in the form of application programming interfaces (APIs) or other feeds. For example, a user may allow information from their personal online account to be sent automatically to the present system. These data fees may be denominated in different currencies with exchange rates brought in by one or more additional feeds that may also utilise APIs or other data interfaces.

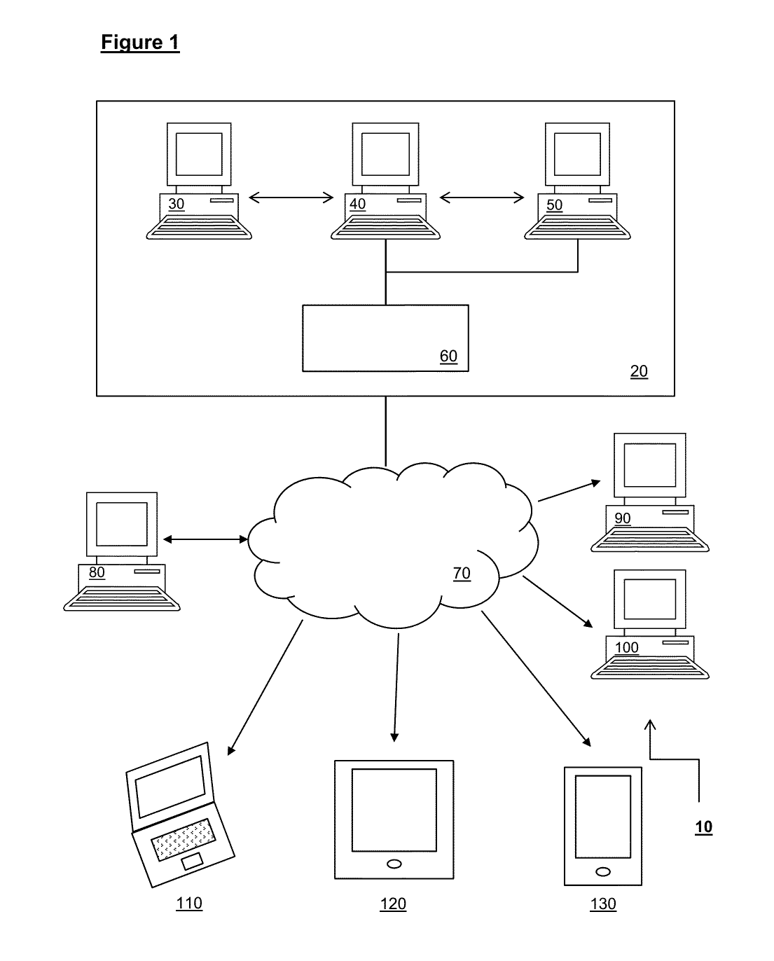

FIG. 1 illustrates infrastructure 10 for providing financial reports to a plurality of users. Infrastructure 10 includes a system 20 for generating the financial reports. In this example, a webserver 40 is in communication with a database server 30 and an email server 50. A firewall 60 provides protection and communications pass through the firewall 60 and into the internet 70.

Financial data including entries associated with assets, liabilities, expenses, revenue and/or equity are provided by one or more institution servers 80, which provide these data to the system 20 through the internet 70. Additionally, reference data such as market, fund and index data may be provided by a reference data server 90. Financial news feeds may be provided by a new server 100 (e.g. Reuters, Bloomberg, etc.).

The financial reports are provided by a system 20 through the internet 70 to particular user devices. These may be communicated to different types of devices including computers 110, tablet computers 120 and/or mobile devices 130 including smartphones and feature phones, for example.

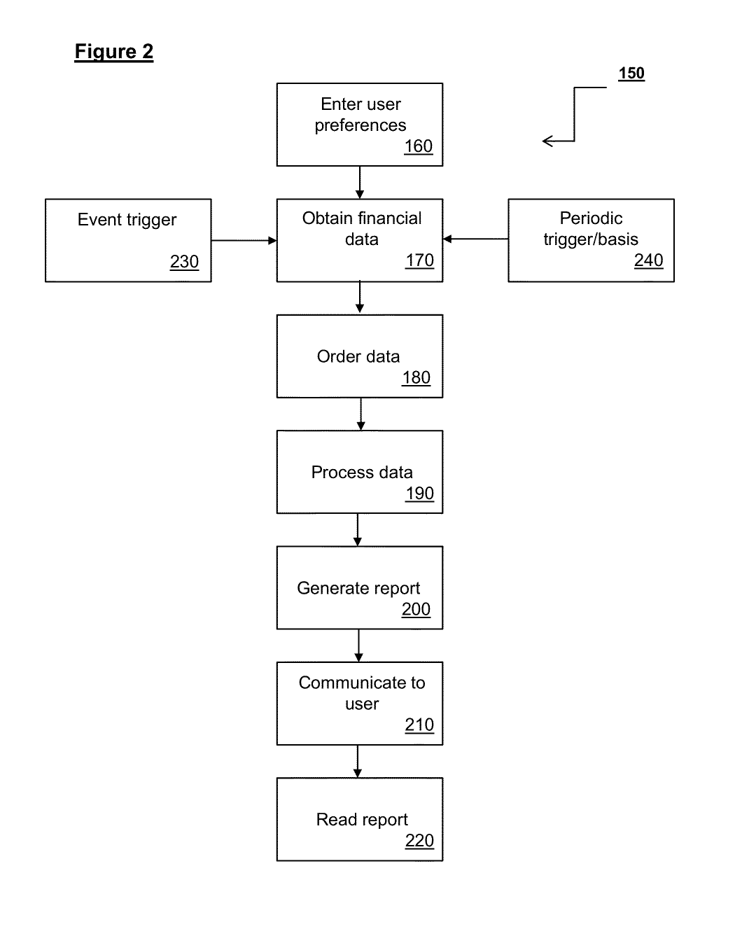

FIG. 2 shows a flowchart of a method 150 for generating a financial report. At step 160, a user may enter their particular preferences and other information. This does not need to be entered each time the method runs as this may be considered a setup or configuration procedure carried out once or whenever changes or updates are required. The particular information that is provided by the user at this stage will be discussed in detail later on but may include particular sources of information, how the user wishes information to be provided, the frequency of the reports and desired reporting currency, for example.

Financial data are obtained at step 170. This may include entries associated with the assets, liabilities, expenses revenues and equity. This part of the method may be triggered by particular events at step 230 or run on a periodic basis according to a schedule at step 240. The set of financial data are ordered according to one or more criterion as defined or inferred by the user preferences at step 180. For example, the user preferences may indicate what is of particular importance or useful information to be provided to the user for a particular data set. Therefore, the ordering of this data may be based on an order of importance or relevance given the preferences and the particular data included in the data set.

The data are processed at step 190 using one or more logical procedures. These logical procedures may be generic for use with many different users or specific to a particular user based on their provided user preferences. Alternatively, user preferences relating to logical procedures may be optional with a default procedure provided unless the user indicates a different preference. The report is then generated at step 200 from the ordered data and formatted data. The logical procedures incorporate the ordered financial data into a natural language narrative or text to form part or all of the financial report. A narrative is provided so that the information maybe more easily understood by the user. There may be many different ways of generating a natural language narrative to incorporate the financial data including the use of templates, decision trees, algorithms and artificial intelligence techniques, for example. The financial report is then communicated to the user at step 210 which may typically be over the internet or other communication interface such as a mobile network, for example. The user may then read or otherwise consume their report at step 220.

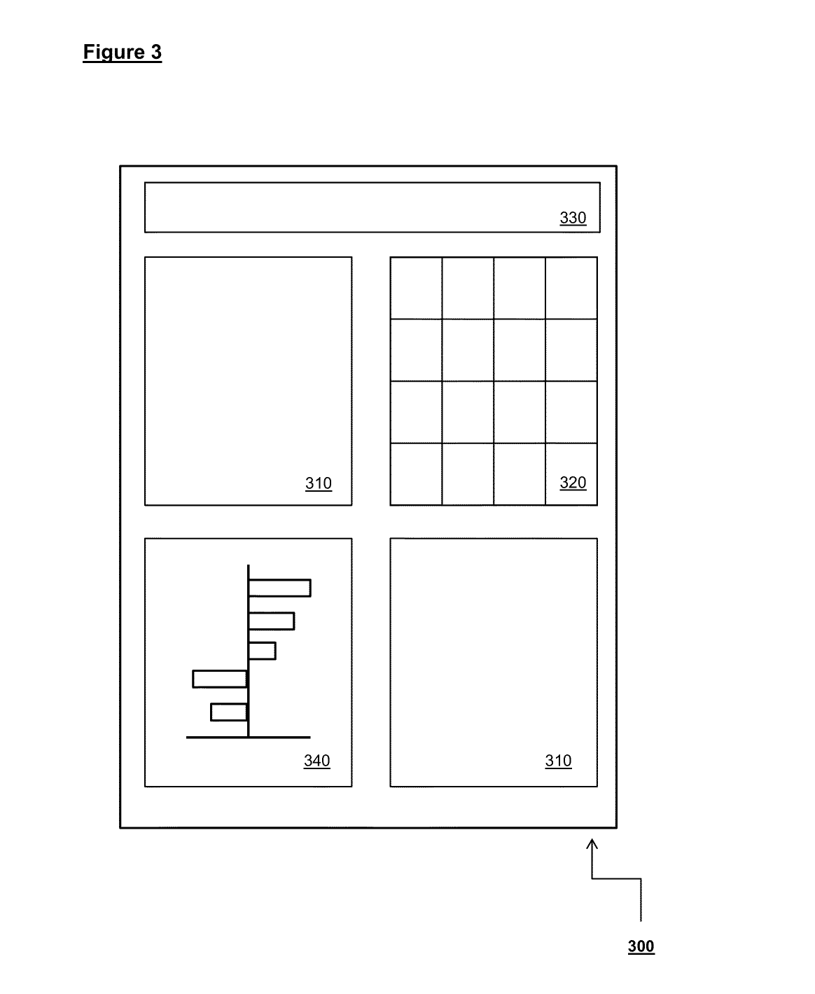

FIG. 3 illustrates schematically a screenshot of a report generated by the system 20 of FIG. 1. This is an example of a report provided in the form of a full page but may be displayed on a computer screen or printed out. This may be in a suitable file format such as the portable document format (pdf) or HTML, for example. The report 300 may comprise different sections including a title section 330.

Text portions 310 may include the financial data in a textual format (e.g. natural language) with tabular data 320 and graphical data 340 interspersed.

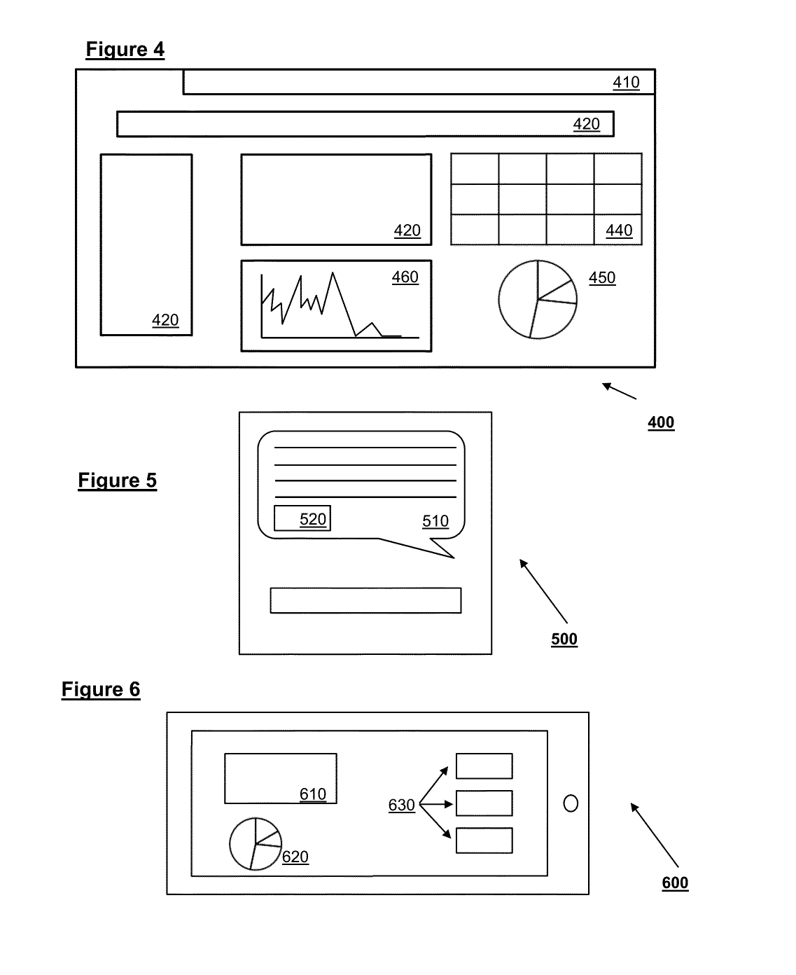

FIG. 4 shows a schematic diagram of the report 400 provided in the form of a webpage having a URL 410. Again, textual portions 420 containing natural language text may be provided together with tabular results 440 and graphical results 450, 460, for example.

FIG. 5 illustrates schematically a financial report 500 provided in the form of an SMS message 510 received on a mobile device 130. The SMS message may also include or be entirely natural language text incorporating the financial data. The SMS message may include a link or URL 520 to provide greater detail than can be supplied in the restricted text format of an SMS.

FIG. 6 shows a schematic diagram of a report 600 provided to a tablet computer 120. Again, textual results 610 may be included with optional graphical results 620. Buttons 630 may be provided to launch particular functions including the ability to drill down into more detail or provide different data to the user. The report 600 may be provided in the form of a mobile application, for example, or may be a mobile device formatted webpage.

The report may also be provided in the form of a dashboard including text and/or graphical items. The dashboard may be presented on any device, including a desktop computer and tablet computer. The information provided by the dashboard may be altered or customised. For example, in that shows a value changing over time, the time axis may be stretched or compacted or a particular period may be expanded. The user may also drill down into such results to obtain finer detail and granularity. For example, a section of a pie chart showing wealth composition for each asset type may be expanded to show each asset and their current value.

The following description illustrates a worked example (step by step) of a user with several accounts. This example follows the method 150 for generating a report. The form of this report is a news article in this example.
Bold font indicates selected fields.

The following are preferences provided by the user (or may be default preferences):

Report based on: [All Accounts/Account Grouping], for Time period: [Last Day/Wk/Mth/Qtr/Custom] in Currency: [USD/GBP/AUD etc.] (principal selections)

### Report Preferences:

Focus report on: [wealth status/making decisions]
Report to use gross or net (after tax) values: [gross/net]
Report Subtotals: [Wealth Source (asset class), Account Grouping, Account Currency, Account Country, None]
(This is the aggregation of individual accounts with the default being by wealth source category (i.e. all bank accounts are under Cash, all Shares subtotalled), but the user may want to report by other groupings such as ‘account groups—a manual grouping’, account currency or account country.)
Make comparisons to previous time periods: [yes/no]
Include actual versus goals in report: [yes/no]
Tone of report: [optimistic/neutral/pessimistic]
Length of report: [Micro (140 chr), Snapshot (1 parag),
Report length (1 page)/In Depth Report (full list)]
Length further customised by materiality: only report events of at least: [$1000]
Include News Headlines: [yes/no]
Include Associated Charts: [yes/no]

### Report Display Preference:

Send to: [Dashboard (screen)/Email/SMS (micro only)/Twitter direct message (micro only)]
If email: [Inline HTML/attach as password protected PDF]
If email: Email address to send to [mailme@email.com] (separate multiple addresses with comma)
If SMS: Enter phone number to send to: [+44798803827]
If Twitter: Enter Twitter screen name: [@_someone]

### Save/Recurring Report Alert Preferences:

### Report Name: [Monthly All Wealth in USD]

If not Dashboard, send: [daily/weekly/monthly/quarterly/bi-annually/annually/custom]

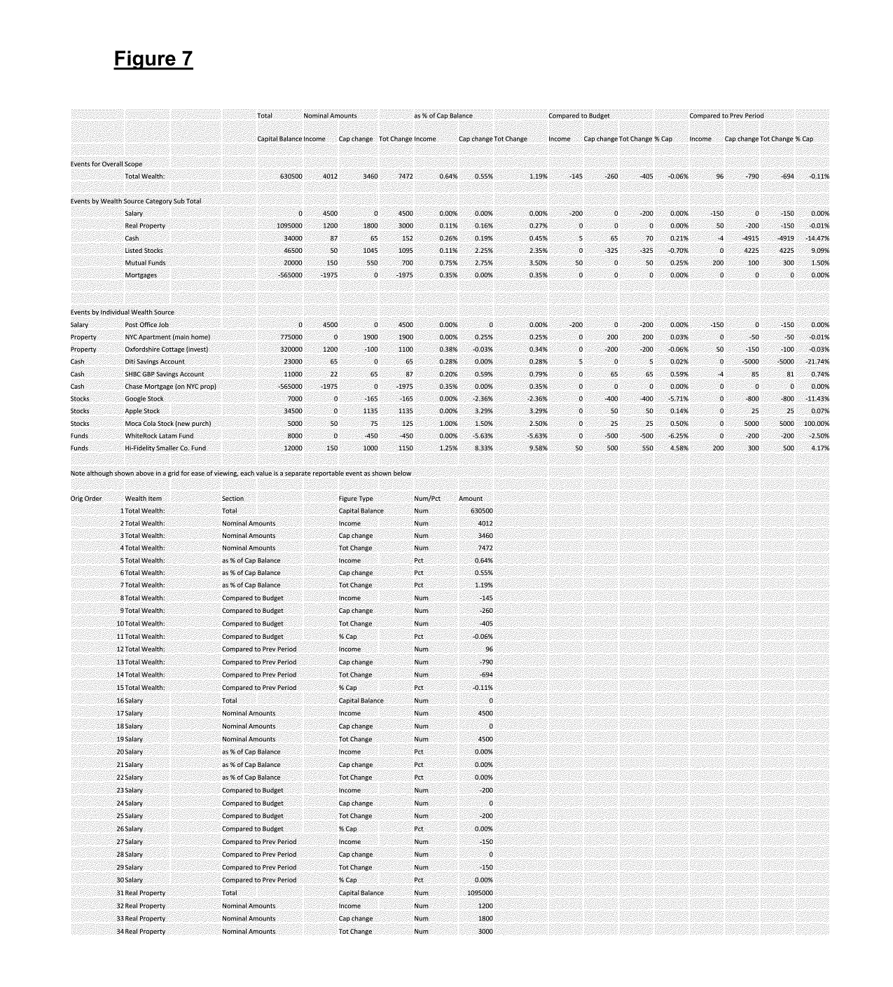

FIG. 7 shows a table of example data. These data may be stored in a computer readable medium or database, for example. The data may be obtained for a number of different sources. These data include income sources, outgoings, cash, stocks, funds and salary. The Events by individual wealth source table section indicates the current value of assets as well as calculated indices (e.g. percentage changes over a period of time). The first column in this table indicates the asset type. The Events by wealth source category table provides a summary of results for all asset types. For example, the total current value of all real property is US$1095000.

The Events for overall scope table indicates total values and derived indices across all asset classes.

These data are partially reproduced in list form below with each value and index shown as a separate entry or event.

The ordering of events determines where they are shown in the report or article (if at all—they may be excluded using limits, for example). According to news article convention, more important items may be shown first and then finer detail later if the user has the time/interest to read that far.

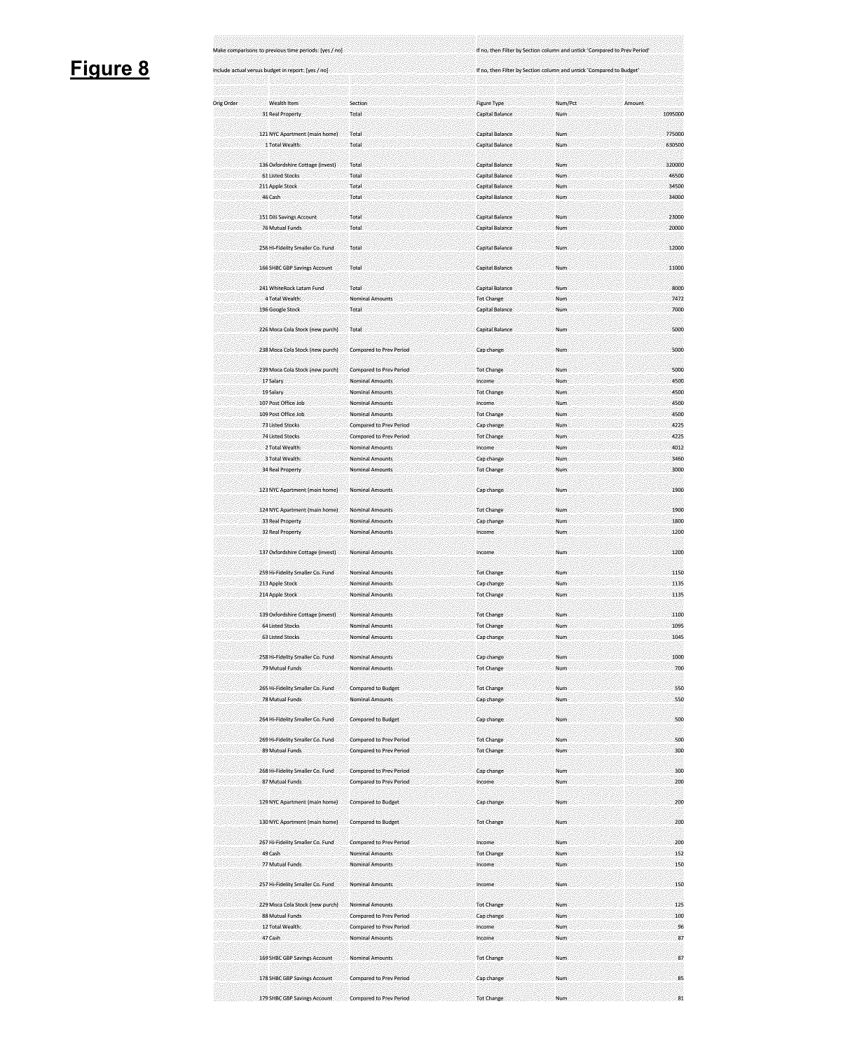

Referring to the example user preferences described above, the user has indicated that they require a report based on all accounts and focussed on wealth status. Therefore, the list form of the data will be ordered with the most significant total wealth values at the top. In other words, as the focus of the report is on wealth status in this example, then events are ordered in descending order of monetary change (as larger absolute changes have greater impact on wealth status.) If the focus of the report was instead on making decisions, then events may be ordered in descending order of % change of item (relative fluctuations are more relevant to make decisions). The result of this ordering of events or values is shown in FIG. 8. It is noted that the highest values are at the top of the list.

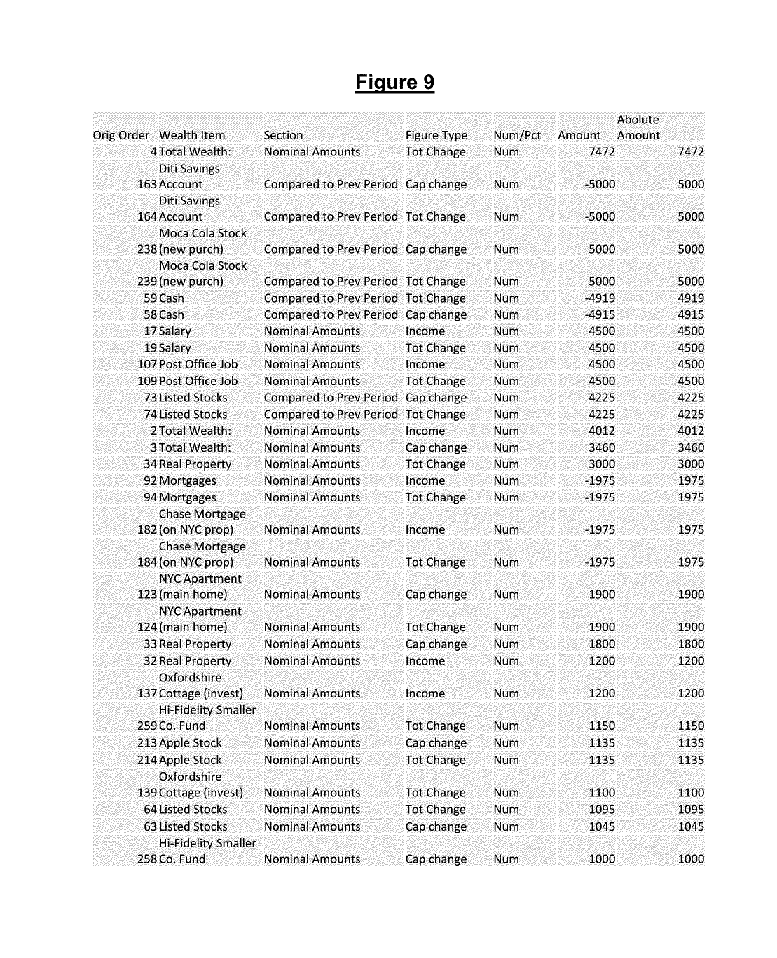

The user preferences also indicate the preferred news article or report length is one page. The user has also indicated that the report is only to include events of at least US$1000. Therefore, these preferences are used to limit the number of events to be included in the report. The result of applying these criteria is shown in the table on FIG. 9.

The report is generated by executing logical procedures. In this example, the logical procedures employ templates to incorporate the ordered and limited values. Example templates for a full news article and an SMS alert are provided below with the extracted values shown in square brackets:

### STOCK PORTFOLIO BOOSTED BY [9%] WITH [MOCA COLA] PURCHASE

### (31 May 2014, London)

(WealthChart)—Listed stocks [increased] by [9%] (to a total value of [$46,500]) with the [May 10] [$5,000] [purchase] of [Moca Cola] stock.
This purchase was funded from [Diti Savings Account] and resulted in a decrease of [14%] of cash ([$34,000] balance after purchase).

### Overall Statement of Position and Change

For the [month of May 2014] overall [increase] in wealth was [$7472], made up of income of [$4012] and capital increase of [$3460].
This [1.19%] increase (total wealth of [$630 k]) is [$694] [below] the [April 2014] gain ([a record of [$8,166]) but progress remains on track for the [2014 budget].
Passive portfolio (excluding salary) showed net [expense] of [$488] and unrealised capital [gain] of [$3,460] on track for total return of [5.6%] pa.

### Wealth Source Round-Up

[Salary] was again the biggest contributor to wealth increase with [$4,500] representing [60%] contribution to wealth increase for the period.
[Real Property] was the next biggest wealth contributor with a total increase of [$3,200] made up [$1,800] capital [gain] and [$1,400] [income].
The estimated total value of [real property] is [$1,095,000] with a mortgage of [$565,000] for net real property wealth of [$530,000], real property making up [84%] of overall wealth.
[Mortgages] were the biggest [expense] for the month of [$1,975] reducing income by [33%] for the period. Mortgage interest rates set to stay low for foreseeable future says Federal Reserve Chair Yellen (click for Wall St. Journal Article)
Stocks were [up] [2.25%] in the month with the biggest gainer being [Apple] up [$1,335 (3.29%)]. Apple iPhone 6 rumoured for release September from WWDC (click for Reuters Article)
Mutual funds increased by [$700] with the largest gain in Fidelity Smaller Funds ($1,150) offsetting the largest faller of WhiteRock Latam fund of [$450].

### Currency & Geography Roundup

[GBP] strengthened by [1%] against [USD] to [0.622] for the period resulting in [$3022] unrealised currency [gain]. [52.5%] of wealth is held in [GBP], with [47.5%] held in [USD].
GBP predicted to continue to strengthen against USD says JPMorgan chief economist.
AUD was virtually unchanged (0.01%) against the USD.

### Individual Account Roundup

[NYC Apartment] saw an unrealised capital [increase] of [$1,900] for the period [(according to FHFA Index)] for a total increase of [0.25%], on track for [3%] p.a total return.
New York residential real estate market cooling according to Real Estate Broker Association Survey (click for full Reuters story).
[Oxfordshire Cottage] realised [income] of [$1,400] for the period but an unrealised capital [loss] of [$100] [according to Bradford House Price Index], on track for a [4.1%] p.a total return.
The next version of this article named ‘Monthly Wealth News’ covering the month of June will be sent on Tuesday, 1 Jul. 2014.
Micro News Article Example: (max 140 character)
Month Wealth May 2014: +$7472 (income: $4012, capital: $3460)+4% avg due to Hi-Fidelity SCF+17%. Tot: $630 k. 2% ahead 2014 target. More: http://w.co/hEv5Hlw
The report may then be communicated to the user in the preferred format (in this example by email).

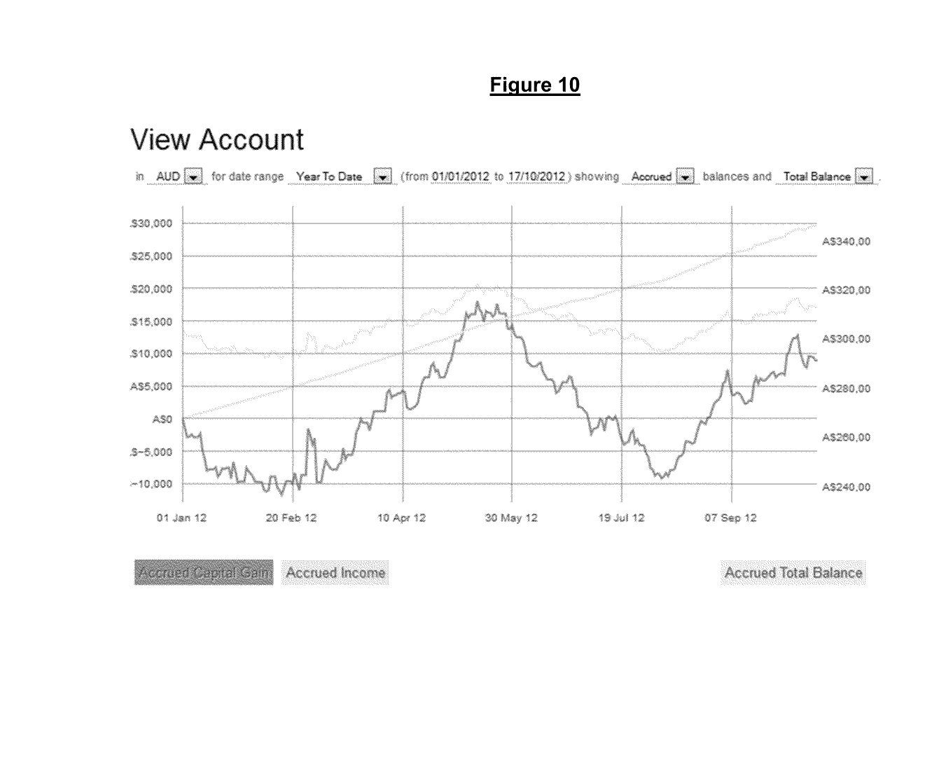

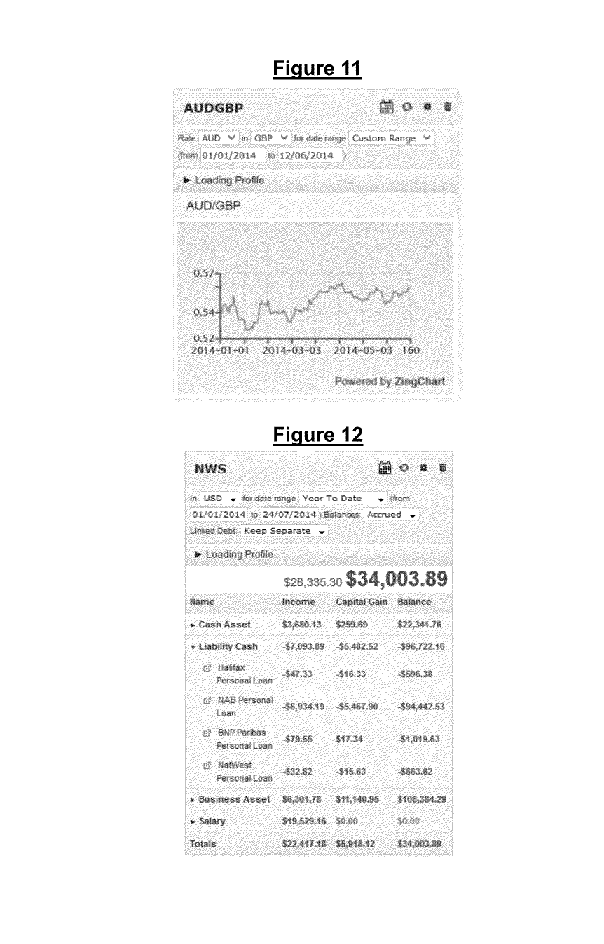

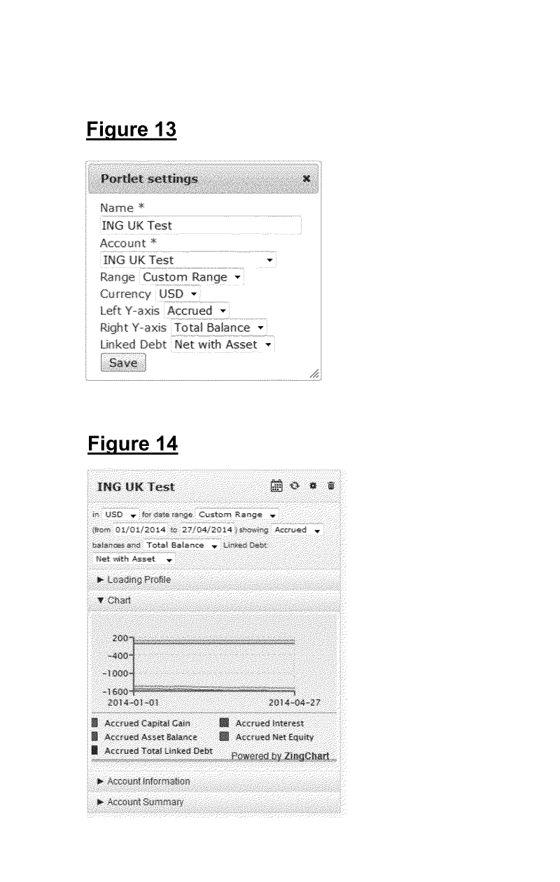

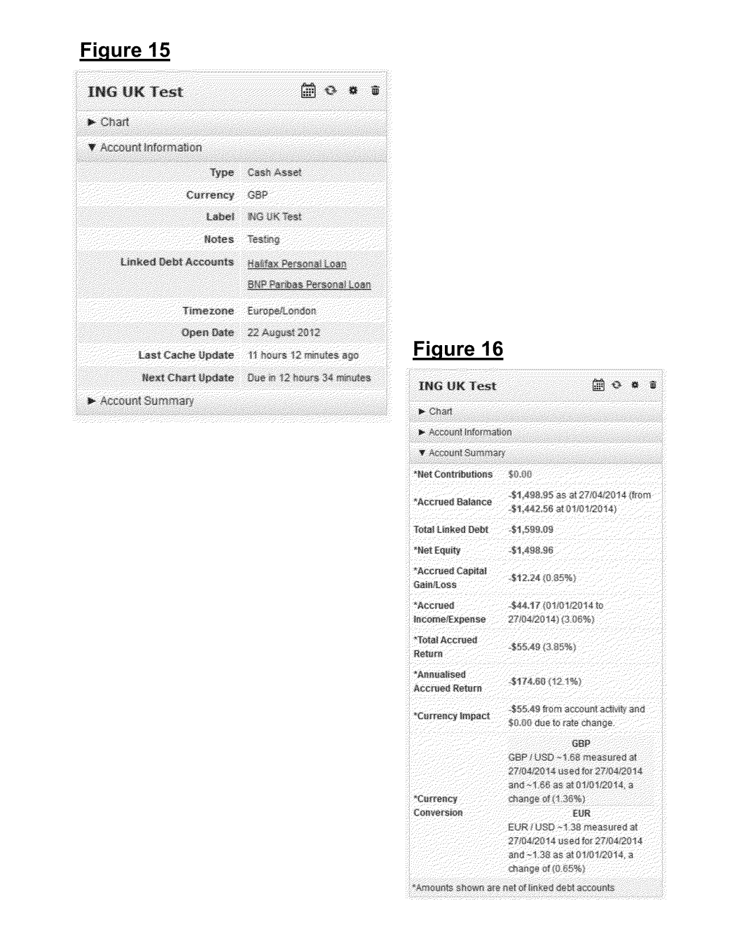

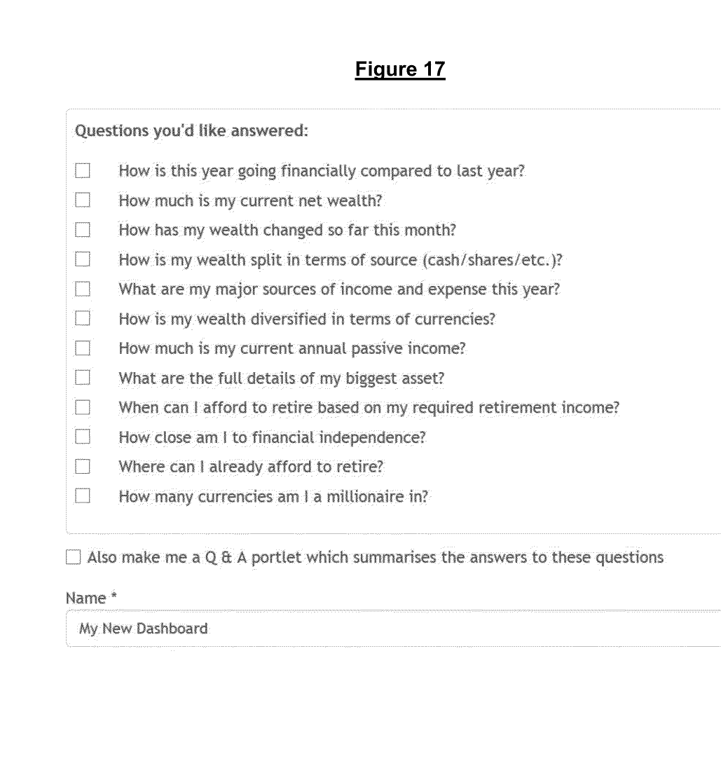

FIGS. 10, 12 and 16 show example screenshots of financial reports of example data only (i.e. not including the natural language narrative). FIGS. 11, 13, 14 and 15 show example screenshots of user interfaces used to provide user information, configuration settings and/or preferences used in the method 150 and by system 20.

Logical procedures are used to automate report generation. A key capability of the system 20 is to display financial data in a more meaningful way to the user. One way to do this is to mine the financial data and according to Report (or user) Preferences generate a natural language report for the user. The report can (again according to report preferences) be in the form of an auto generated Dashboard with the text report being one portlet and related charts (if user prefers) as other portlets to form a custom dashboard. Alternatively, the report may be an emailed PDF/HTML report, or a micro-report in the form of an SMS or Twitter/social media post.

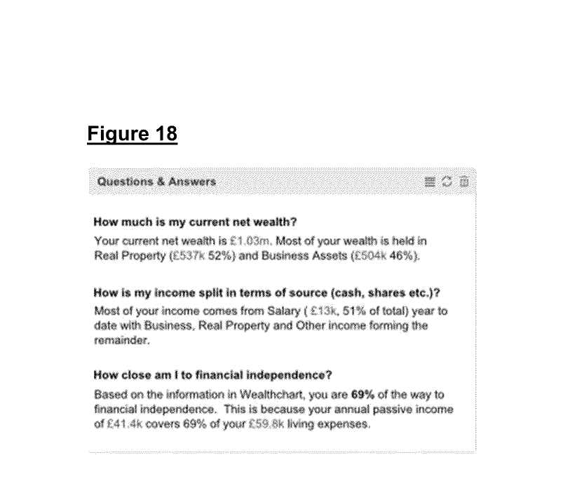

Natural language reports may take many different forms. For example, the reports may take the form of one or more answers to questions. In other words, the report may be generated having a “Q and A” style. The actual questions being answered may be selected by the user. FIG. 17 shows a screenshot of such selectable questions for the user to choose by ticking particular boxes next to each question. This selection forms part or all of the user's preferences. Any number of questions may be selected and form the basis of the natural language report.

FIG. 18 shows an example natural language report for using this question and answer format.

The following describes example functional methodology and logical procedures used to provide automated report generation in the form of a natural language output incorporating financial data. This may be summarised as separate stages or steps:

1. Report Preferences;

2. Report Data Generation;

3. Report Data Ordering;

4. Report Data Limitation;

5. Report Generation; and

6. Report Sending

Report preferences is the first step in this example of Automated Report Generation where the user sets (and saves for later) report generation. It is a user interactive step to set up and then the reports will be automatically generated (as per Alerts. Example user preferences are shown below with default selections shown in bold text:

### Report Principal Selections

| Label | Entry Type | Description |
|---|---|---|
| Report | Dropdown: [All | This is the scope of the |
| Scope | Accounts/Account Groups | report - being either |
| | list] | all accounts or subset |
| | | of account groups |
| Report | Dropdown: [Preset timing | This is the time scope |
| Time | list (Last Day/Mth/Qtr | of the report |
| Period | etc. or Custom with | |
| | from/to date selection] | |
| Report | Dropdown: [UBC/list of | This is the selected |
| Currency | all other currencies] | currency for reporting |
| Period | | |

### Report Content Preferences

| Label | Entry Type | Description |
|---|---|---|
| Focus Report | Dropdown: [Wealth | This preference determines |
| on | Status/Making | which financial data is |
| | decisions] | reported (in which order) |
| | | to the user |
| Report | Dropdown: [Wealth | Subtotal grouping of |
| Subtotals | Source (asset | accounts in the report - |
| | class), Account | the default is Wealth |
| | Grouping, Account | Source (asset class: Cash, |
| | Currency, Account | Real Property etc.) but |
| | Country, None | the user may which to |
| | | report on other subtotals |
| Gross or Net | Dropdown: | Whether the report uses |
| Report | [Gross/Net] | gross or net (after taxes) |
| | | figures |
| Comparison to | Dropdown: [Yes/No] | This preference determines |
| Previous Time | | if comparisons are made to |
| Periods | | previous equivalent time |
| | | period to the report |
| Comparison to | Dropdown: [Yes/No] | This preference determines |
| Budgets | | if comparisons are made to |
| | | budgets (if set) in the |
| | | report |
| Tone of Report | Dropdown: [Neutral/ | This preference sets the |
| | Optimistic | tone of the report by |
| | Pessimistic] | selecting different |
| | | template sentences |
| Length of | Dropdown: [News | This preference sets the |
| Report | Article Length (1-2 | length of the report which |
| | pages)/Snapshot (1 | then loads appropriate |
| | paragraph)/Micro | templates in report |
| | (140 chr)/In | generation |
| | Depth Report] | |
| Report Limit by | Text [(number - or | ‘Only report data for |
| Materiality | blank)] | amounts over [entry] |
| | | amount.’ This preference |
| | | (if set) further restricts |
| | | the length of the report |
| | | by limiting to data to |
| | | certain value. Note that |
| | | the length of the report |
| | | (except In Depth Report) |
| | | will already limit to fit |
| | | the report length - this |
| | | preference may act as a |
| | | further limit if set. |
| Include | Dropdown: [Yes/No] | This preference is whether |
| Title/Headline | | the report generates a |
| | | title (N/A to micro). If |
| | | yes is selected, the auto |
| | | generated title attempts |
| | | to be the most important |
| | | ‘headline’ fact in the |
| | | report. |
| Show Associated | Dropdown: [Yes/No] | This preference is whether |
| Charts/Tables | | the report shows |
| | | associated charts/tables |
| | | (N/A for micro). |

### Report Display Preferences

| Label | Entry Type | Description |
|---|---|---|
| Report Name | Text: [eg. Monthly All | Save report preferences |
| | Wealth in USD] | to edit later |
| Send to | Tick Boxes: [Dashboard | How to send the report - |
| | (screen)/Email/SMS | may be multiple |
| | (micro only)/Twitter | |
| | personal msg (micro | |
| | only)] | |
| Report Send | Dropdown: [None/Daily/ | If not Dashboard, then |
| Frequency | Weekly/Monthly/ | set frequency of send |
| | Quarterly/Bi-annually/ | |
| | Annually] | |
| If email | Dropdown: Type: [PDF/ | If email, set |
| | Inline HTML] Email | preferences |
| | Address: [text] | |
| | (separate multiple | |
| | emails with commas) | |
| If SMS | Mobile phone number: | If SMS set phone |
| | [+44XXX] | number |
| If Twitter | Twitter Screen Name: | If Twitter set screen |
| | [@_someone] | name to send |
| | | personal/direct message |

Following this step, once the user preferences are validated and saved the next stage of Report Data Generation is entered.

### Report Data Generation

The Report data generation step is an internal system process (not user interactive) and is the first internal process to generate an automated report based on saved user Report Preferences. Report data elements are generated from each user account (based on report scope report preference) and depends on the following 3 report preferences:
Report Subtotals—Dropdown: [Wealth Source (asset class), Account Grouping, Account Currency, Account Country, None—Subtotal grouping of accounts in the report—the default is Wealth Source (asset class: Cash, Real Property etc.) but the user may select other subtotals
Comparison to Previous Time Periods—Dropdown: [Yes/No]—if No, Compared to Previous Period category data elements below not included
Comparison to Budgets—Dropdown:[Yes/No]—If No, Compared to Budget category data elements below not included
   Data is generated from individual user accounts according to data elements which provide a piece of information on the account based on report parameters of time-frame and currency—eg. the total balance of a user HSBC UK Current Account of £50.00 as at reporting date of 1 Jun. 2014. Data elements are either: empirical spot (eg. total balance as at report end date), empirical range (eg. income over report time period), an aggregration (eg. total return=income+capital change) or comparison (eg. income compared to budget or total return percentage).The report data elements are then aggregated by Report Subtotals forming additional report data elements as described below.

### Report Data Elements

The report data elements are the individual data elements used in the reports and are as follows:

| Data | Data | Calculation (column | |
|---|---|---|---|
| Element | Element | from Time Series | |
| Category | Name | Dataset) | Description |
| Total | Capital | Total (19) | This is the capital |
| | Balance | | balance as at report |
| | | | end date |
| Nominal | Income | Income (13) | This is the income |
| Amounts | | | (or expense if |
| | | | negative) over the |
| | | | report period |
| | Capital | CapitalGain (23) | This is the capital |
| | Change | | change over the |
| | | | report period |
| | Total | CapitalGain (23) + | This is the total |
| | Change | Income (13) | change over the |
| | | | report period |
| % of Cap | Income | Income (13)/(19) | This is the income |
| Balance | | | (or expense if |
| | | | negative) (as % of |
| | | | Cap Balance) over |
| | | | the report period |
| | Capital | CapitalGain (23)/ | This is the capital |
| | Change | (19) | change (as % of Cap |
| | | | Balance) over the |
| | | | report period |
| | Total | (CapitalGain (23) + | This is the total |
| | Change | Income (13))/(19) | change (as % of Cap |
| | | | Balance) over the |
| | | | report period |
| Compared | Income | Income (13) − Budget | This is the income |
| to | | Income (TBC) | (or expense if |
| Budget | | | negative) compared |
| | | | to budget over the |
| | | | report period |
| | Capital | CapitalGain (23) − | This is the capital |
| | Change | Budget CaptialGain | change compared to |
| | | (TBC) | budget over the |
| | | | report period |
| | Total | (CapitalGain (23) + | This is the total |
| | Change | Income (13)) − | change compared to |
| | | (Budget Income (TBC) + | budget over the |
| | | Budget CaptialGain | report period |
| | | (TBC)) | |
| | Total | (CapitalGain (23) + | This is the total |
| | Change % | Income (13)) − | change compared to |
| | Capital | (Budget Income (TBC) + | budget as a |
| | | Budget CaptialGain | percentage of |
| | | (TBC)/Total (19)) | account Total |
| | | | Balance over the |
| | | | report period |
| Compared | Income | Income (13) − | This is the income |
| to | | Previous Income | (or expense if |
| Previous | | (Calc) | negative) compared |
| Period | | | to budget over the |
| | | | report period |
| | Capital | CapitalGain (23) − | This is the capital |
| | Change | Previous CaptialGain | change compared to |
| | | (Calc) | budget over the |
| | | | report period |
| | Total | (CapitalGain (23) + | This is the total |
| | Change | Income (13)) − | change compared to |
| | | (Previous Income | budget over the |
| | | (Calc) + Previous | report period |
| | | CaptialGain (Calc)) | |
| | Total | (CapitalGain (23) + | This is the total |
| | Change % | Income (13)) − | change compared to |
| | Capital | (Previous Income | budget as a |
| | | (Calc) + Previous | percentage of |
| | | CaptialGain (Calc)/ | account Total |
| | | Total (19)) | Balance over the |
| | | | report period |

### Report Subtotals/Totals

The report elements above are further grouped into Report Subtotals, which are aggregations of account level data elements as selected by the user preference. Report data levels are as follows:

| Data Level | Parent of | | |
|---|---|---|---|
| Name | Data Level | Examples | Description |
| Overall | Wealth | Total | Top data level. This is |
| Scope | Account | Wealth | a single total |
| | Subtotals | | aggregation of either |
| | | | total wealth or subset |
| | | | if Account Groups are |
| | | | selected as the report |
| | | | scope |
| Wealth | Individual | Wealth | Aggregation of accounts |
| Account | Wealth | Source/ | by selected category |
| Subtotals | Account | Account | (default class of asset) |
| | | Groups | such as cash, real |
| | | (see user | property, funds etc. |
| | | pref) | |
| Individual | None - | SHBC Bank | Individual wealth source |
| Wealth | bottom | Account | account of user. |
| Account | level | ending | |
| | | 8421, | |
| | | Yodafone | |
| | | Shares | |

### Report Data Ordering

Report data ordering is the second automated step in Automated Report Generation and orders the data generated in the preceding step of Report Data Generation. The ordering of the data is based on the Report Preferences of:
Focus Report on: Dropdown: [Wealth Status/Making Decisions]
   If the focus of the article is on Wealth Status, the data is ordered in descending order of nominal monetary change—as bigger absolute changes have greater impact on wealth status.
   If the focus of the report is on Making Decisions, data is ordered in descending order of % change of item as relative fluctuations are more relevant to make decisions than absolute changes.

### Report Data Limitation

Report data limitation is the third automated step in Automated Report Generation and (potentially) limits the data sorted in the preceding step of Report Data Ordering. The limiting of the data is based on the 2 Report Preferences of:
Length of Report Dropdown: [News Article Length (1-2 pages)/Snapshot (1 paragraph)/Micro (140 chr)/In Depth Report]—This preference sets the length of the report which limits data and loads appropriate templates in the next Report Generation step.
Report Limit by Materiality (optional)—Text [(number—or blank)]—This further (potentially) limits reported data items based on materiality of amount—eg. only report data items greater than $500.

Length of Report limitations continue to be fine-tuned in combination with template integration in the next Report Generation step, but limiting parameters at this stage per report type are as follows:

| Report Type | Data Level | Limitation |
|---|---|---|
| News Article (1-2 | Total Wealth | Shown - no |
| pages) | | limitation |
| | Wealth Source | Shown - Top 4 |
| | Sub Total | only |
| | Individual | Shown - Top 2 |
| | Wealth Source | only |
| Snapshot (1 para) | Total Wealth | Shown - no |
| | | limitation |
| | Wealth Source | Shown - Top 2 |
| | Sub Total | Only |
| | Individual | Shown - Top 1 |
| | Wealth Source | only |
| Micro (140 chars) | Total Wealth | Shown - no |
| | | limitation |
| | Wealth Source | Shown - Top 1 |
| | Sub Total | only |
| | Individual | Shown - Top 1 |
| | Wealth Source | Only |
| In Depth Report | Total Wealth | Shown - no |
| | | limitation |
| | Wealth Source | Shown - no |
| | Sub Total | limitation |
| | Individual | Shown - no |
| | Wealth Source | limitation |

Report Generation

Report generation is the fourth automated step in Automated Report Generation and builds the report from the data prepared in preceding steps. The generating of the report is based on the data plus the following 3 Report Preferences of:
Length of Report—Dropdown: [News Article Length (1-2 pages)/Snapshot (1 paragraph)/Micro (140 chr)/In Depth Report]—This preference loads appropriate template for generating the report.
Include Title/Headline—Dropdown: [Yes/No]—This preference is whether the report generates a title (N/A to micro) which is an optional element in the template.
Show Associated Charts/Tables—Dropdown: [Yes/No]—This preference is whether the report shows associated charts/tables (N/A for micro) which is determined by logic in the template.

Automated Report Templates: Text

An Automated Report Template is a flexible rule-based text generator engine within the Automated Report Generation system. It is the key step of translating abstract data (prepared in earlier steps) into meaningful text for the user to read. While this engine is complex in its implementation, a simplified outline of the template logic is shown in the following table:

| Report | | |
|---|---|---|
| Type | Template Logic | Example Text |
| News | If headline_pref = ‘yes’ then | STOCK |
| Article | [Headline_txt] | PORTFOLIO |
| (1-2 | ([end_date_report], [Time_zone_city]) | BOOSTED BY |
| pages) | (WealthChart) - | 9% WITH |
| | [Headline_wealth_source_name] | MOCA COLA |
| | [Headline_wealth_inc_dec] by | PURCHASE |
| | [Headline_wealth_change_%] (to a | (31 May 2014, |
| | total value of | London) |
| | [Headline_wealth_amt]) with the | (WealthChart) - |
| | [headline_event_date] | Listed stocks |
| | [headline_event_purchase_amt] | increased by 9% (to |
| | [headline_event_type] of | a total value of |
| | [headline_event_account_name]. | $46,500) with the |
| | If | May 10 $5,000 |
| | [headline_event_type] = ‘new_purchase’ | purchase of Moca |
| | and [funding_source] = internal | Cola stock. |
| | then: | This purchase was |
| | [This purchase was funded from | funded from Diti |
| | [fund_account_source_name] and | Savings Account and |
| | resulted in a decrease of | resulted in a |
| | [fund_account_source_diff_%] of | decrease of 14% of |
| | [fund account_wealth_source] | cash ($34,000 |
| | ([fund_account_source_diff_amt] | balance after |
| | balance after purchase). | purchase). |
| | For the [report_period] overall | For the month of |
| | [tot_gain_inc_dec] in wealth was | May 2014 overall |
| | [tot_gain], made up of income of | increase in wealth |
| | [tot_income] and capital increase | was $7472, made up |
| | of [tot_capital]. | of income of $4012 |
| | If compare_prev_periods = ‘yes’ | and capital |
| | then: | increase of $3460. |
| | This [tot_wealth_inc_%] | This 1.19% increase |
| | [tot_wealth_inc_dec] (total wealth | (total wealth of |
| | of [tot_wealth]) is | $630k) is $694 |
| | [comp_period_tot_gain_amt] | below the April |
| | [comp_period_tot_gain_ab_bel] the | 2014 gain (a record |
| | [comp_period_name] gain ([a record | of $8,166) but |
| | of [comp_period_tot_gain]) | progress remains on |
| | If compare_budget = ‘yes’ and | track for the 2014 |
| | [Overall_Budget_default] Isset, | budget. |
| | then: | Passive portfolio |
| | but | (excluding salary) |
| | [Overall_Budget_default_macro_statement] | showed net expense |
| | for the [Overall_Budget_default_name]. | of $488 and |
| | Passive portfolio (excluding | unrealised capital |
| | salary) showed net | gain of $3,460 on |
| | [passive_inc_exp] of | track for total |
| | [passive_income] and unrealised | return of 5.6% pa. |
| | capital | Wealth Source |
| | [passive_capital_gain_loss] of | Round-up |
| | [passive_capital_gain_amt] on | Salary was again |
| | track for total return of | the biggest |
| | [passive_yield] pa. | contributor to |
| | Wealth Source Round-up | wealth increase |
| | For each Wealth_source in | with $4,500 |
| | decending order of absolute | representing 60% |
| | amount: | contribution to |
| | [Wealth_source_name] was [If | wealth increase for |
| | salary_order = unchanged, then: | the period. |
| | again] the [order_statement_txt] | Real Property was |
| | to wealth increase with | the next biggest |
| | [wealth_source_amt] | wealth contributor |
| | If [wealth_source_capital <>0 | with a total |
| | then: (made up [$1,800] capital | increase of $3,200 |
| | [gain] and [$1,400] [income]), | made up $1,800 |
| | representing | capital gain and |
| | [wealth_sourse_amt_tot_%] | $1,400 income. |
| | contribution to wealth increase | The estimated total |
| | for the period. [If exists: | value of real |
| | wealth_source_news_article_headline]. | property is |
| | Repeat: top 4 wealth sources | $1,095,000 with a |
| | Currency & Geography Roundup | mortgage of |
| | [user_base_currency_code] | $565,000 for net |
| | [main_forex_pair_direction] by | real property |
| | [UBC_second_currency_code] against | wealth of $530,000, |
| | [second_currency_code] to | real property |
| | [main_forex_rate_end] for the | making up 84% of |
| | period resulting in | overall wealth. |
| | [main_forex_capital_amt] | Mortgages were the |
| | unrealised currency | biggest expense for |
| | [main_forex_capital_gain_loss]. | the month of $1,975 |
| | [ubc_perc_tot_holdings] of wealth | reducing income by |
| | is held in | 33% for the period. |
| | [user_base_currency_code], with | Mortgage interest |
| | [UBC_second_currency_perc_holdings] | rates set to stay |
| | held in [UBC_second_currency_code]. | low for foreseeable |
| | GBP predicted to continue to | future says Federal |
| | strengthen against USD says | Reserve Chair |
| | J P Morgan chief economist, | Yellen (click for |
| | [forex_3_code] was | Wall St. Journal |
| | [forex_2_3_macro_statment] against | Article) |
| | the [forex_2_code]. | Stocks were up |
| | Individual Account Roundup | 2.25% in the month |
| | For each Wealth_source in | with the biggest |
| | decending order of absolute | gainer being Apple |
| | amount: | up $1,335 (3.29%). |
| | [wealth_account_name] saw an | Apple iPhone 6 |
| | [wealth_account_name_inc_dec] of | rumoured for |
| | [wealth_cap] for the period for a | release September |
| | total increase of | from WWDC (click |
| | [wealth_cap_perc], on track for | for Reuters |
| | [wealth_yield] p.a total return. | Article) |
| | [account_news_headline]. | Mutual funds |
| | Repeat: top 2 wealth accounts | increased by $700 |
| | The next version of this article | with the largest |
| | named ‘[report name]’ covering | gain in Hi-Fidelity |
| | [report_next_period_name] will be | Smaller Funds |
| | sent on | ($1,150) offsetting |
| | [report_next_send_date_long]. | the largest faller |
| | | of WhiteRock Latam |
| | | fund of $450. |
| | | Currency & |
| | | Geography Roundup |
| | | GBP strengthened by |
| | | 1% against USD to |
| | | 0.622 for the |
| | | period resulting in |
| | | $3022 unrealised |
| | | currency gain. |
| | | 52.5% of wealth is |
| | | held in GBP, with |
| | | 47.5% held in USD. |
| | | GBP predicted to |
| | | continue to |
| | | strengthen against |
| | | USD says J P Morgan |
| | | chief economist. |
| | | AUD was virtually |
| | | unchanged (0.01%) |
| | | against the USD. |
| | | Individual Account |
| | | Roundup |
| | | NYC Apartment saw |
| | | an unrealised |
| | | capital increase of |
| | | $1,900 for the |
| | | period (according |
| | | to FHFA Index) for |
| | | a total increase of |
| | | 0.25%, on track for |
| | | 3% p.a total |
| | | return. |
| | | New York |
| | | residential real |
| | | estate market |
| | | cooling according |
| | | to Real Estate |
| | | Broker Association |
| | | Survey (click for |
| | | full Reuters |
| | | story). |
| | | Oxfordshire Cottage |
| | | realised income of |
| | | $1,400 for the |
| | | period but an |
| | | unrealised capital |
| | | loss of $100 |
| | | according to |
| | | Bradford House |
| | | Price Index, on |
| | | track for a 4.1% |
| | | p.a total return. |
| | | The next version of |
| | | this article named |
| | | ‘Monthly Wealth |
| | | News’ covering the |
| | | month of June will |
| | | be sent on Tuesday, |
| | | 1 Jul. 2014. |
| Snapshot | If headline_pref = ‘yes’ then | STOCK |
| (1 para) | [Headline_txt] | PORTFOLIO |
| | ([end_date_report],[Time_zone_city]) | BOOSTED |
| | (WealthChart) - | BY 9% WITH |
| | [Headline_wealth_source_name] | MOCA COLA |
| | [Headline_wealth_inc_dec] by | PURCHASE |
| | [Headline_wealth_change_%] (to a | (31 May 2014, |
| | total value of | London) |
| | [Headline_wealth_amt]) with the | (WealthChart) - |
| | [headline_event_date] | Listed stocks |
| | [headline_event_purchase_amt] | increased by 9% (to |
| | [headline_event_type] of | a total value of |
| | [headline_event_account_name]. | $46,500) with the |
| | For the [report_period] overall | May 10 $5,000 |
| | [tot_gain_inc_dec] in wealth was | purchase of Moca |
| | [tot_gain], made up of income of | Cola stock. For the |
| | [tot_income] and capital increase | month of May 2014 |
| | of [tot_capital]. | overall increase in |
| | If compare_prev_periods = ‘yes’ | wealth was $7472, |
| | then: | made up of income |
| | This [tot_wealth_inc_%] | of $4012 and |
| | [tot_wealth_inc_dec] (total wealth | capital increase of |
| | of [tot_wealth]) is | $3460. |
| | [comp_period_tot_gain_amt] | This 1.19% increase |
| | [comp_period_tot_gain_ab_bel] the | (total wealth of |
| | [comp_period_name] gain ([a record | $630k) is $694 |
| | of [comp_period_tot_gain]) | below the April |
| | If compare_budget = ‘yes’ and | 2014 gain (a record |
| | [Overall_Budget_default] Isset, | of $8,166) but |
| | then: | progress remains on |
| | but | track for the 2014 |
| | [Overall_Budget_default_macro_statement] | budget. |
| | for the [Overall_Budget_default_name]. | Salary was again |
| | For each Wealth_source in | the biggest |
| | decending order of absolute | contributor to |
| | amount: | wealth increase |
| | [Wealth_source_name] was [If | with $4,500 |
| | salary_order = unchanged, then: | representing 60% |
| | again] the [order_statement_txt] | contribution to |
| | to wealth increase with | wealth increase for |
| | [wealth_source_amt] | the period. |
| | If [wealth_source_capital <>0 | Real Property was |
| | then: (made up [$1,800] capital | the next biggest |
| | [gain] and [$1,400] [income]), | wealth contributor |
| | representing | with a total |
| | [wealth_sourse_amt_tot_%] | increase of $3,200 |
| | contribution to wealth increase | made up $1,800 |
| | for the period. | capital gain and |
| | Repeat: top 2 wealth sources | $1,400 income. |
| | For each Wealth_source in | NYC Apartment saw |
| | decending order of absolute | an unrealised |
| | amount: | capital increase of |
| | [wealth_account_name] saw an | $1,900 for the |
| | [wealth_account_name_inc_dec] of | period (according |
| | [wealth_cap] for the period for a | to FHFA Index) for |
| | total increase of | a total increase of |
| | [wealth_cap_perc], on track for | 0.25%, on track for |
| | [wealth_yield] p.a total return. | 3% p.a total |
| | Repeat: top 1 wealth accounts | return. |
| Micro | [Report name: trunc: 15chr] | Month Wealth May |
| (140 | [time frame: 10chr]: [tot_gain] | 2014: +$7472 |
| chars) | ([income: [tot_income], capital | (income: $4012, |
| | [tot_capital]). | capital: $3460) +4% |
| | If compare_prev_periods = ‘yes’ | avg due to Hi- |
| | then: | Fidelity SCF +17%. |
| | [+/− comp_to_prev_period] due to | Tot wealth: $630k. +2% |
| | [+/− | 2014 target. |
| | greatest account change prev]. | |
| | Total Net Wealth [tot_net_wealth] | |
| | If compare_budget = ‘yes’ and | |
| | [Overall_Budget_default] Isset, | |
| | then: | |
| | +/− %comp_to_budget_degault] to | |
| | [Overall_Budget_default_name | |
| | trunc: 10]. | |
| In Depth | As per News Article except for | See News Article - |
| Report | repeats: | but expanded to all |
| (all | Repeat: All wealth sources | wealth sources and |
| accounts) | Repeat: All wealth accounts | accounts |

Automated Report Templates: Associated Charts/Tables

If the user preference to show associated charts/tables, following text template construction, there is a direct mapping to the type of portlet charts and text as follows:

| Metric Type | From Portlet | Chart Type |
|---|---|---|
| Wealth by Source | Net Wealth table | Net Wealth by Source |
| | | Table |
| Account Overall | Net Wealth by | Horizontal Bar Chart |
| contribution | Account | |
| Currency Round-up | Net Wealth by | Currency Pie Chart/ |
| | Currency | World Map |
| Sector Round-up | Net Wealth by | Wealth by Sector Pie |
| | Sector | Chart |
| Individual Account | Single Account | 6 Series Line Chart |
| details | | |

Once the report generation processing is complete, the next (and final) step is Report Sending.

Report Sending

Report sending is the final step in the Automated Report Generation process. It is conditional on the Report Display preferences:

Report Display Preferences

| Label | Entry Type | Description |
|---|---|---|
| Report Name | Text: [eg. Monthly All | Save report preferences |
| | Wealth in USD] | to edit later |
| Send to | Tick Boxes: [Dashboard | How to send the report - |
| | (screen)/Email/SMS | may be multiple |
| | (micro only)/Twitter | |
| | personal msg (micro | |
| | only)] | |
| Report Send | Dropdown: [None/Daily/ | If not Dashboard, then |
| Frequency | Weekly/Monthly/ | set frequency of send |
| | Quarterly/Bi-annually/ | |
| | Annually] | |
| If email | Dropdown: Type: [PDF/ | If email, set |
| | Inline HTML] Email | preferences |
| | Address: [text] | |
| | (separate multiple | |
| | emails with commas) | |
| If SMS | Mobile phone number: | If SMS set phone |
| | [+44XXX] | number |
| If Twitter | Twitter Screen Name: | If Twitter set screen |
| | [@_someone] | name to send |
| | | personal/direct message |

Report sending can be divided into 2 discrete steps of report packaging and report transmission as described below.

Report Packaging

Report packaging steps depends on the format of the report and all reports (except for raw text) are derived from first saving the report as a Dashboard and then converting from there for non-screen reports. The first step of saving as a Dashboard is because the system may be optimised for dealing with Dashboards and saving as a Dashboard gives the user further opportunity (if they wish) to manually tweak the report.
HTML (Screen): The report text is saved in a Report portlet (updating an existing Report portlet if this is sending an existing report) and the charts selected in Report Generation are loaded/updated as Portlets also on the Dashboard page.
HTML (Email): The HTML (screen) step above is first undertaken to update the Dashboard, and then the existing alert functionality transforms the Dashboard into a static HTML representation for sending by email.
PDF (Email): The HTML (screen) step above is first undertaken to update the Dashboard, and then the HTML to PDF conversion takes place to convert the Dashboard (with updated content) into a PDF for emailing to the user.
Raw Text (SMS/Twitter): The text of the story is saved in the same database table directly with the report preferences

Report Transmission

The final step of Report Sending is report transmission, and depends on the Send to User preference as follows:
Screen: Once packaged the user is simply redirected to the new/updated Dashboard page. If the user is viewing on the mobile site or app the Dashboard will be configured to suit the device type.
Email (HTML/PDF): The packaged report is sent to the user email address saved in preferences via the email gateway.
SMS: The text of the story is then sent to the PHP to SMS gateway along with the user telephone number saved in ‘If SMS’ user preference.
Twitter: The text of the story is then sent to the PHP to Twitter script along with the user screen name number saved in ‘If Twitter’ user preference.

Confirmation of successful transmission (date/time and method sent) is recorded in the User Preferences table so the user can see the status of the send in the Report/index page.

This then concludes the Automated Report Generation process.

As will be appreciated by the skilled person, details of the above embodiment may be varied without departing from the scope of the present invention, as defined by the appended claims.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A method of generating a financial report comprising the steps of:
obtaining a set of financial data including entries associated with one or more of expenses, revenue, equity, assets or liabilities;
ordering the financial data entries according to one or more criterion defined by user preferences;
processing the ordered financial data by applying one or more logical procedures to incorporate the financial data into a natural language narrative of a financial report; and
communicating the financial report to the user.

2. The method of claim 1, wherein the one or more logical procedures are executed according to attributes within the user preferences.

3. The method of claim 1 further comprising the step of obtaining new or updated user preferences from the user, wherein the processing step further comprises limiting the ordered financial data entries to include in the financial report, based on the user preferences, and
wherein the steps are repeated to generate and communicate a further financial report to the user and the ordered financial data are limited to a number of the most significant entries indicated by a value threshold within the user preferences.

4. The method of claim 1, wherein the one or more logical procedures include any one or more of: including the financial data entries within textual templates; applying one or more rules to the financial data; formatting the financial data using one or more templates; and executing an algorithm.

5. The method of claim 1, wherein the financial report is communicated to the user by any one or more selected from the group comprising: email, in pdf form, SMS message, social media feed, mobile application, web page, in HTML, and using an application programming interface, API.

6. The method of claim 1, wherein the financial report is communicated to the user in the form of a customisable dashboard, wherein the dashboard customisations are stored, and wherein a further financial report is communicated according to the stored dashboard customisations.

7. The method of claim 1, wherein the steps are repeated when triggered by an event or an interval, and wherein the trigger is defined by the user preferences.

8. The method of claim 1, wherein the set of financial data are any one or more selected from the group comprising: equity, shares, stock, bonds, debt, rent, income, salary, real estate, mortgage, managed fund, mutual fund, limited stock, share incentive scheme, individual savings account, ISA, transactions, automobile, fine wine, coins, stamps, precious metal, jewellery, art works, business, trust, financial instrument, intellectual property, financial derivatives, commodities, superannuation, or pension.

9. The method of claim 1 further comprising the step of:
calculating and adding to the financial report any one or more of: total asset value, total liabilities, asset class value, net wealth, net wealth change, individual asset value change, capital gains, tax, values or value changes in different currencies, user goals, user goal position, time to goal at current rate of change, trends over time, time-frame comparison, income, outgoings, comparison of values and trends for different currencies, and inflation.

10. The method of claim 1 further comprising the steps of:
determining a device type of the user; and
selecting the one or more logical procedures based on the determined device type, wherein the device type is any device, a mobile device, a smartphone, a feature phone, a tablet computer, a desktop computer, or a laptop computer.

11. The method of claim 1, wherein the one or more templates include any one or more of: sample text, text size, one or more graphical elements; graphical element size, page layout, title, and headline.

12. The method of claim 1, wherein obtaining the set of financial data further includes obtaining the financial data from different sources or organisations, and wherein the set of financial data are obtained by manually or automatically importing a data set.

13. The method of claim 1, wherein the financial report is generated using natural language generation.

14. The method according to any previous claim, wherein the user preferences define the set of financial data to obtain.

15. The method of claim 1 further comprising the step of:
generating one or more of a graphical representation of the financial data or a tabular representation of the financial data.

16. A system comprising:
a processor; and
memory storing computer readable instructions which, when executed by the processor, configure the system to:
obtain a set of financial data including entries associated with one or more of expenses, revenue, equity, assets or liabilities;
order the financial data entries according to one or more criterion defined by user preferences;
process the ordered financial data by applying one or more logical procedures to incorporate the financial data into a natural language narrative of a financial report; and
communicate a financial report to the user.

17. The system of claim 16 further comprising one or more interfaces for receiving financial data for a plurality of financial data sources.

18. The system of claim 16, further comprising a user interface for obtaining or updating the user preferences.

19. The system of claim 16 further comprising a web application configured to obtain or update the user preferences and communicate the financial report to the user.

20. A non-transitory computer readable storage medium storing computer readable instructions which, when executed by a computer, instruct the computer to perform steps comprising:
obtaining a set of financial data including entries associated with one or more of expenses, revenue, equity, assets or liabilities;
ordering the financial data entries according to one or more criterion defined by user preferences;
processing the ordered financial data by applying one or more logical procedures to incorporate the financial data into a natural language narrative of a financial report; and
communicating the financial report to the user.
